(19) United States
(12) Patent Application Publication
(10) Pub. No.: US 2014/0060971 A1
(43) Pub. Date: Mar. 6, 2014

(54) Fire Escape Ladder

(71) Applicants: Dzevat Selimovic, New York, NY (US); Almir Selimovic, New York, NY (US)

(72) Inventors: Dzevat Selimovic, New York, NY (US); Almir Selimovic, New York, NY (US)

(21) Appl. No.: 13/972,840

(22) Filed: Aug. 21, 2013

Related U.S. Application Data
(60) Provisional application No. 61/691,657, filed on Aug. 21, 2012.

(51) Int. Cl. E06C 9/00

(52) U.S. Cl. CPC E06C 9/00
USPC 182/70

(57) ABSTRACT

The invention provides a Fire Escape Ladder comprising a portable and compactable climbing instrument in a durably constructed wooden rectangular box. The box may serve as a seat when not in use. The ladder inside the box comprises a series of rectangular rungs connected to each other and anchored to the bottom of the box with strong heavy steel chain links. The storage box contains a lip extension from its top edge for attaching, locking in and stabilizing the Fire Escape Ladder at a window opening.

### CLAIM OF PRIORITY

This patent application claims priority under 35 USC 119 (e) (1) from U.S. Provisional Patent Application Ser. No. 61/691,657 filed Aug. 21, 2012, of common inventorship herewith entitled, “Fire Escape Ladder.”

### FIELD OF THE INVENTION

The present invention pertains to the field of residential fires, and more specifically to the field of fire escape ladders.

### BACKGROUND OF THE INVENTION

The prior art has put forth several designs for fire escape ladders. Among these are:

U.S. Pat. No. 5,842,539 to Marion S. Hough describes a fire escape system that includes a ladder permanently attached with cleats to an interior surface of a box that functions both for storage of the ladder and for anchorage of the ladder when in use. The box has a rear side to be placed against a building wall and optionally secured thereto at a position below a window sill and a top ledge mounted on the rear wall. Cleats are mounted to the rear wall are disposed rearwardly of a front edge of the ledge to provide for force applied during use of the ladder to aid in forcing the box against a building wall to inhibit movement of the box during use of the ladder. The ladders used in the system may be constructed of chains with metal rungs.

U.S. Pat. No. 5,908,082 to Wallace J. Turner and Alray Turner describes a fire escape ladder which includes recessed steps which are mounted into an interior or exterior wall of a house or the concrete walls of a basement to provide an escape route to a window. When the ladder is used, the lock to the window is automatically released and springs in the window frame cause the window to partially open. An associated smoke detector or a connection to the household smoke detector activates lights in the recessed steps and an audible alarm which aids in egress from a dark or smoke filled building.

U.S. Pat. No. 5,203,427 to Anthony E. Williams, Sr. and Alonda O. Williams describes a portable fire escape ladder with an inflatable air cushion. The ladder has an upper window sill engaging portion and a plurality of frame members interconnected with rungs. The air bag is inflated by propellant from a trigger operable propellant source for decelerating a person prior to alighting on the ground.

None of these prior art references describe the present invention.

### SUMMARY OF THE INVENTION

It is an object of the present invention to provide a lightweight and efficient fire escape ladder contained within an attractive wooden stool.

### BRIEF DESCRIPTION OF THE DRAWINGS

FIG. 1 is a prototypical diagonal view showing a ladder extending out of its storage box.

FIG. 2 is a prototypical functional diagonal view showing a ladder extending downward outside an upper level window.

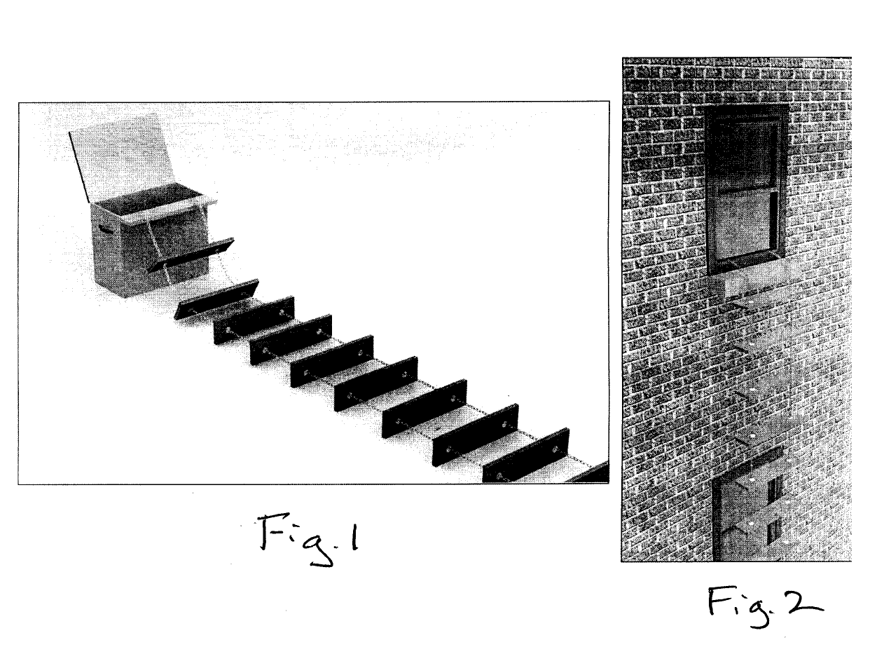

### DETAILED DESCRIPTION OF THE INVENTION

Each year, an unacceptable number of people lose their lives in residential structure fires where smoke alarms operated. Fire officials diligently investigate characteristics of these fire victims to better educate the public in taking preventative measures to reduce risks involved with residential fires. Officials discovered that most of these fatal statistics relate to structures unequipped with a potentially lifesaving means of exiting a burning building, specifically, a fire escape. Mostly found in metropolitan areas, fire escapes are usually in multiple story residential buildings such as apartment buildings. A set of stairs found on an outside area of each unit in a building facilitates a quick exit and in fire situations, fire escapes have saved thousands of lives over many decades. The tragic casualties due to fires usually occur in smaller towns and communities to families in standard family dwellings who have no fire escape on floors above ground level.

The present invention, hereinafter referred to as the Fire Escape Ladder, is a portable and compactable climbing instrument specially designed for residential use in the event of a fire. The present invention provides consumers a quickly accessible means of escape from upper floors in a burning home or building that is unequipped with a conventional fire escape. The Fire Escape Ladder is a durably constructed wooden rectangular box, having dimensions of approximately twenty four inches in height, twenty two inches in length, seventeen inches in top width and twelve inches in bottom width. During down time, the box may serve as a handy foot stool or may be upholstered with a comfortable decorative cushion at its top to serve as a makeshift seat. The box contains a handle on each side to facilitate easy transport of the unit from one location to another. A hinge mounted lid opens to reveal a receptacle which houses the Fire Escape Ladder. The ladder comprises a series of rectangular rungs measuring approximately twenty inches in length. These rungs are connected to each other and anchored to the bottom of the box with strong heavy steel chain links. The Fire Escape Ladder has a sufficient amount of rungs to facilitate safe escape from a second or third floor window. The storage receptacle contains a lip extension from its top edge for attaching, locking in and stabilizing the Fire Escape Ladder at a window opening.

Extremely effective in application, using the Fire Escape Ladder is very easy and straightforward. In the event of a fire, the Fire Escape Ladder box is moved quickly to a window that serves as the egress route and fitted over the window sill using the lip extension. Locking the box in place, the rungs are removed from the confines of the storage area and dropped down out of the open window. Each individual carefully descends the Fire Escape Ladder to quickly leave the burning building. The present invention is compactable ladder system that is deployable in a matter of seconds. Placed next to bedroom, bathroom or hallway windows, the compact and lightweight Fire Escape Ladder enables residents to leave their home immediately. The Fire Escape Ladder also is invaluable for two story and three story business structures, particularly hotels and motels with only a couple of floors. Manufactured of durable, high quality materials and components, the Fire Escape Ladder will withstand years of continued use.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A lightweight and efficient fire escape ladder contained within an attractive wooden storage box comprising: a durably constructed wooden rectangular box, having dimensions of approximately twenty four inches in height, twenty two inches in length, seventeen inches in top width and twelve inches in bottom width, further comprising a handle on each side of the box to facilitate easy transport of the unit from one location to another, further comprising a hingedly mounted lid, further comprising ladder comprising a series of rectangular rungs measuring approximately twenty inches in length, wherein the rungs are connected to each other and anchored to the bottom of the box with strong heavy steel chain links.

2. The lightweight and efficient fire escape ladder of claim 1, wherein the ladder has a sufficient amount of rungs to facilitate safe escape from a second or third floor window.

3. The lightweight and efficient fire escape ladder of claim 1, wherein the storage box contains a lip extension from its top edge for secure attachment and locking in and stabilizing the ladder at a window opening.

4. The lightweight and efficient fire escape ladder of claim 1, wherein the storage box is capable of serving as a handy foot stool or may be upholstered with a comfortable decorative cushion at its top to serve as a seat.
